(19) United States
(12) Patent Application Publication
(10) Pub. No.: US 2025/0256466 A1
(43) Pub. Date: Aug. 14, 2025

(54) COMPOSITE WHEEL WITH FIBER-REINFORCED MOLDING COMPOUND HAVING MULTIPLE RESIN CHEMISTRIES, AND METHOD

(71) Applicant: Lacks Enterprises, Inc., Grand Rapids, MI (US)

(72) Inventor: Colin Snyder, Caledonia, MI (US)

(21) Appl. No.: 19/046,632

(22) Filed: Feb. 6, 2025

Related U.S. Application Data
(60) Provisional application No. 63/551,611, filed on Feb. 9, 2024.

(51) Int. Cl. B29C 65/70; B29C 31/08; B29C 37/00; B29C 65/00; B29C 65/78; B29K 105/14; B29L 31/32

(52) U.S. Cl. CPC B29C 65/70; B29C 31/085; B29C 37/0067; B29C 65/7802; B29C 66/02241; B29C 2791/002; B29K 2105/14; B29K 2995/0051; B29L 2031/32

(57) ABSTRACT

A composite wheel structure is made from a fiber-reinforced molding compound (FRMC) material having different resins at different axial sections of the wheel. The FRMC material can be provided as a roll of material, with different resin chemistries at different lateral sections, and applied to a wheel mold such that the different resin chemistries are provided at different axial sections. A single carrier film may have different resin chemistries at different sections, and chopped reinforcement fibers can be deposited across the width of the film. Multiple separate carrier films with different resin chemistries can be arranged side by side, and the chopped fibers added to the combined width. Reinforcing material can be provided in a prepreg and chopped and added to single carrier film at different width sections. The chopped fibers and different resins can be impregnated together to define the multi-resin FRMC material for use in the wheel layup.

### FIELD

The present disclosure relates to a vehicle wheel construction. More particularly, the present disclosure relates to a composite vehicle wheel construction including fiber-reinforced molding compound and different properties across the axial direction of the wheel.

### BACKGROUND OF THE DISCLOSURE

Passenger vehicle wheels are known in the art, and are typically formed of one or more materials to define the shape of the wheel. The wheel may be sized and shaped such that it is configured to support a tire mounted thereon, and such that the wheel may be mounted to a rotatable axle so the wheel can be driven by a vehicle transmission and rotated in response to the vehicle being driven.

Different portions of the wheel have different strength or temperature requirements based on the different functions performed by the different portions. Accordingly, the wheel may have various thicknesses, fiber angles, and/or reinforcement materials that are used throughout the different wheel portions or areas.

For example, a typical wheel may include a pair of tire bead flanges, such as an inner bead flange and an outer bead flange. The bead flanges typically must have very high impact performance and toughness to perform well when subjected to a pothole impact. Thus, increasing the toughness at this area is advantageous.

It is also known that in the area of the wheel that interfaces with the vehicle brake calipers, it is desirable to have an elevated temperature performance, such that the wheel material can sufficiently withstand the increased temperatures that result from the friction generated during a braking operation.

Typical composite wheel manufacturing processes utilize the same resin or material matrix for the entire wheel construction. This process therefore results in a single material being used for each of the areas of the wheel. Wheels may be manufactured using the same resin and varying the radial thickness of the wheel to provide different strengths at different portions of the wheel. Nevertheless, the use of the same matrix material will result in a compromise between strength, temperature performance, and cost.

One solution for the different requirements of the wheel is the use of different resins for different portions of the wheel. In some approaches, different resins can be “co-cured” to produce a wheel with different strength and temperature performance at different locations.

Various approaches may be used to construct a wheel with different resins. In one approach, a first preform is constructed which includes one matrix system, which may be uncured or already cured. A second preform may be constructed using a different matrix system, which may be cured or uncured. The preforms may then be placed in a mold together and then cured together.

In another approach, a preform, such as a fiber preform, may be placed in a Resin Transfer Mold (RTM), where a liquid thermoset resin is used to saturate the fiber preform in a closed mold. The result is that the preform becomes embedded in the thermoset resin. In this approach, a first matrix system may be infused into one region of the preform, and a second matrix system is infused into another region of the preform. The two matrix systems may then be cured together to define an overall composite with the embedded preform.

The above-described methods are typically used for simplifying the bonding of multiple composite parts. The result is typically a difference in thickness along the axial width of the wheel. Put another way, there can be multiple layers of material. In this approach, each layer uses the same matrix, but some of the layers along the thickness of the wheel have different properties.

In the above-described approach, the reinforcement materials are not continuous across the multiple resin regions. Put another way, one reinforcement area with a first resin material will overlap another portion with a reinforcement area with a second resin, such that the first resin overlaps the second resin at an increased thickness area. This method is known as an overlap method, and is illustrated in FIG. 1.

In another approach, known as the splice method and shown in FIG. 2, a first resin material is formed in layers with different lengths, such that a middle layer may have a longer length, and is received in a recess formed between layers, with the second resin material having a shorter length such that the longer length can be received in a recess defined by the shorter length.

The overlap and/or seam that is created in these prior art solutions is undesirable and can create a part that is overly bulky or lacking in a desirable strength.

In view of the above, improvements can be made to the construction and reinforcement of composite vehicle wheels.

### SUMMARY OF THE DISCLOSURE

It is an aspect of this disclosure to provide a composite wheel structure with different strength and temperature characteristics in different axial portions of the wheel.

It is a further aspect of this disclosure to provide a composite wheel structure with a reduced cost.

It is a further aspect of this disclosure to provide a composite wheel structure formed from a fiber-reinforced molding compound (FRMC) material having different resin chemistries and strength/temperature properties at different axial sections of the wheel.

It is another aspect of this disclosure to provide a composite wheel structure with a continuous reinforcement layer.

It is another aspect of this disclosure to provide a method of creating an FRMC material roll having different resin chemistries at different widths or zones, such that the FRMC material can be applied to the wheel mold to provide different FRMC resin chemistries at the different axial locations.

In one aspect, a single carrier film having multiple resins receives chopped fibers thereon and is impregnated and provided into a roll of multi-resin FRMC material.

In one aspect, multiple carrier films, each having a different resin, are arranged side-by-side and combined, which receives chopped reinforcement material across the combined width of the carrier films, which are impregnated and combined together into a roll of multi-resin FRMC material.

In one aspect, multiple single-resin FRMC prepregs are provided and chopped, and deposited in different zones across the width of a single carrier film, and then impregnated and rolled into a roll of multi-resin FRMC material. Alternatively, the chopped prepreg fiber may be deposited directly to a wheel mold, layup aid, or similar tooling, allowing deposition of chopped prepreg fiber of various resin chemistry to different portions of the wheel preform(s).

In one aspect, a composite wheel structure includes: a wheel body defining an axis of rotation, an axial extent, and a first axial section and a second axial section adjacent the first axial section disposed within the axial extent; at least one layer of composite material extending axially through the first and second axial sections; wherein the composite material is a fiber-reinforced molding compound (FRMC) material having a plurality of fibers distributed randomly along the axial extent through the first and second axial sections; wherein the FRMC material has a first resin chemistry in the first axial section and a second resin chemistry in the second axial section, wherein the first and second resin chemistries are different and have different strength and temperature characteristics.

In one aspect the composite wheel structure includes at least one oriented fiber reinforcement extending circumferentially through the FRMC material and fully around the axis of rotation.

In one aspect the composite wheel structure includes at least one continuous fiber reinforcement layer extending circumferentially fully around the axis of rotation and axially through the first and second axial sections.

In one aspect, the wheel body includes a rim and a wheel center integrally formed with an axial end section of the rim, wherein the wheel center includes at least one layer of FRMC material.

In another aspect, a method of creating a fiber-reinforced molding compound (FRMC) for use in constructing a composite wheel structure includes the steps of: providing at least one carrier film having an overall lateral width; depositing chopped fibers randomly onto the at least one carrier film; combining the chopped fibers with first and second resins on the at least one carrier film, wherein the first and second resins having different resin chemistries, wherein the first resin is disposed in a first lateral section of the overall lateral width and the second resin is disposed on a second lateral section of the overall lateral width; and impregnating the first and second resins with the chopped fibers and defining a FRMC material.

In one aspect, the at least one carrier film is a single carrier film having the overall lateral width and the first and second resins are each deposited on the single carrier film.

In one aspect, the first and second resins are deposited on the single carrier film prior to depositing the chopped fibers onto the single carrier film.

In one aspect, the at least one carrier film comprises a first carrier film and a second carrier film, wherein the first carrier film defines a first lateral width and the second carrier film defines a second lateral width, wherein the first and second lateral width combine to define at least a portion of the overall lateral width, wherein the first resin is disposed on the first carrier film and the second resin is disposed on the second carrier film.

In one aspect, the first resin is deposited on the first carrier film prior to depositing the chopped fibers and the second resin is deposited on the second carrier film prior to depositing the chopped fibers.

In one aspect, the method includes laminating the chopped fibers with at least one further carrier film applied onto the chopped fibers.

In one aspect, the further carrier film has further first and second resins, wherein the further carrier film is laminated such that the further first resin overlies the first resin, and the further second resin overlies the second resin.

In one aspect, the chopped fibers are provided from a roll of reinforcement fiber.

In one aspect, the chopped fibers are provided from a unidirectional prepreg material having unidirectional fibers and the first or second resin, wherein the unidirectional prepreg material is chopped and provides both the chopped fibers and the first or second resin onto the at least one carrier film.

In one aspect, the FRMC material is formed into a roll after the impregnation step.

In one aspect, the method includes layering the FRMC material on a wheel mold, such that a first axial section of the wheel mold has the first resin with the chopped fibers and a second axial section of the wheel mold has the second resin with the chopped fibers, and forming a composite wheel having the FRMC material with different resin chemistries in different axial sections of the composite wheel.

In one aspect, the at least one carrier film is provided as a bare carrier film from a roll without the first and/or second resins, and the first and second resins are deposited on the at least one carrier film in line with the depositing, combining, and impregnating steps.

In one aspect, the depositing of the chopped fibers onto the at least one carrier film occurs prior to depositing the first and/or second resin.

In one aspect, the at least one carrier film is provided from a roll with the first and/or second resin pre-deposited on the roll.

In one aspect, the chopped fibers are deposited randomly and continuously across the overall lateral width of the at least one carrier film.

In another aspect, a method of constructing a reinforced composite wheel on a mold tool having an axial extent includes the steps of: providing a first unidirectional prepreg material having a first resin chemistry and unidirectional reinforcing fibers; providing a second unidirectional prepreg material having a second resin chemistry and unidirectional reinforcing fibers; slicing and chopping the first unidirectional prepreg material to define a first chopped prepreg; slicing and chopping the second unidirectional prepreg material to define a second chopped prepreg; depositing the first chopped prepreg directly onto a first axial section of the mold tool; depositing the second chopped prepreg directly onto a second axial section of the mold tool; and producing a fiber-reinforced layer of material in the mold tool from the first and second chopped prepregs, wherein the fiber-reinforced layer of material has different resin chemistries at different axial sections of the mold for producing a composite wheel having an axial extent with different resin chemistries at different axial sections.

### A BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a schematic view of a prior art system in which multiple matrix materials and multiple reinforcement layers overlap each other;

FIG. 2 is a schematic view of a prior art system in which multiple matrix materials and multiple reinforcement layers are spliced together;

FIG. 3 is fragmentary perspective view of a composite wheel having multiple matrix materials across an axial width of the wheel;

FIG. 4A is a schematic cross-sectional view illustrating a continuous reinforcement layer having multiple matrix materials, showing the reinforcement layer after consolidating the reinforcement layer and the multiple matrix materials;

FIG. 4B is a schematic cross-sectional view illustrating a continuous reinforcement layer having multiple matrix materials, showing the reinforcement layer before consolidating the matrix materials with the continuous reinforcement layer;

FIG. 5 is a perspective view illustrating multiple matrix films being applied to a single reinforcement layer;

FIG. 6 is a perspective view of a manufacturing setup illustrating multiple matrix materials being applied to a single substrate for later being applied to a single reinforcement layer;

FIG. 7 is a schematic view of a composite wheel having at least one layer of FRMC material with different resin chemistries at different axial locations;

FIG. 8 is a schematic view of a wheel rim portion having at least one layer of FRMC material with different resin chemistries at different axial locations;

FIG. 9 is a perspective view of a roll of FRMC prepreg material for use in the wheel layup process, having different resin chemistries at different widths or zones;

FIG. 10A-B illustrates a method of making the FRMC prepreg material of FIG. 9 by adding chopped reinforcement fibers to a single carrier film having different resins in different widths or zones following by lamination, impregnation, rolling;

FIG. 11A-D illustrates another method of making the FRMC prepreg material, including joining multiple separate carrier films having different resins side-by-side and depositing chopped fibers to the combined carrier film; and

FIG. 12A-B illustrates another method of making the FRMC prepreg material, including providing multiple single-resin FRMC prepregs, chopping the prepregs, and depositing the chopped prepregs onto a single carrier film, followed by impregnation and rolling into a final FRMC prepreg roll having multiple resin chemistries in different widths or zones.

### DESCRIPTION OF THE DISCLOSURE

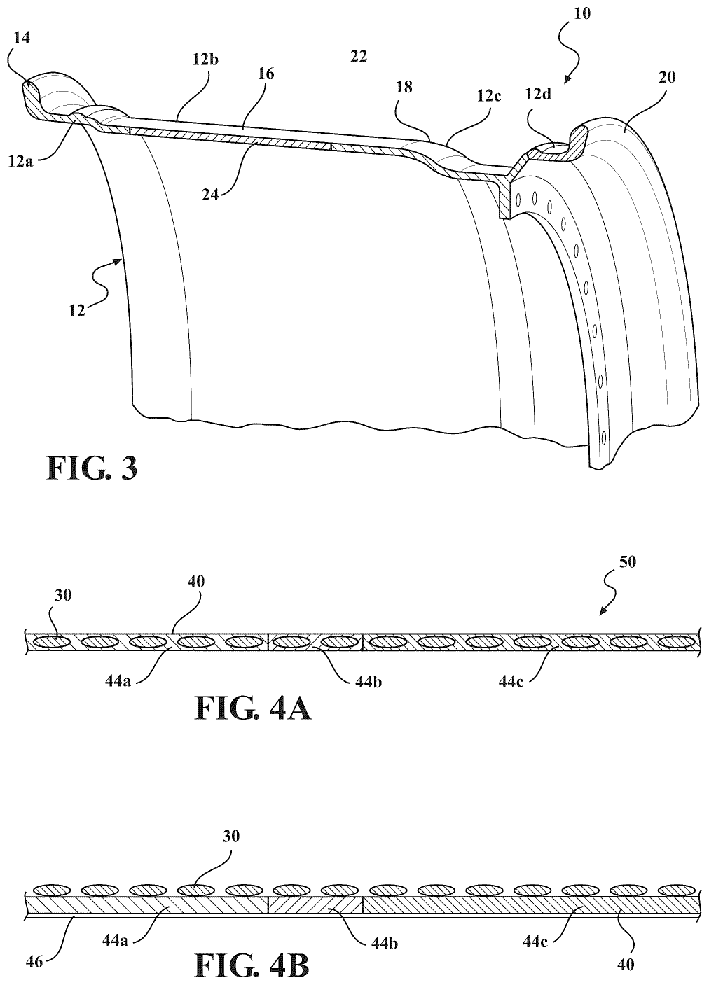

Referring to FIG. 3, a vehicle wheel 10 construction is provided having multiple matrix materials across the axial width of the wheel 10. The wheel 10 may include a wheel body 12 having multiple axial zones, areas, or portions 12a, b, c, d, etc. The body portions may be referred to generally using the reference numeral 12, with specific zones being referred to as 12a, b, c, d, etc.

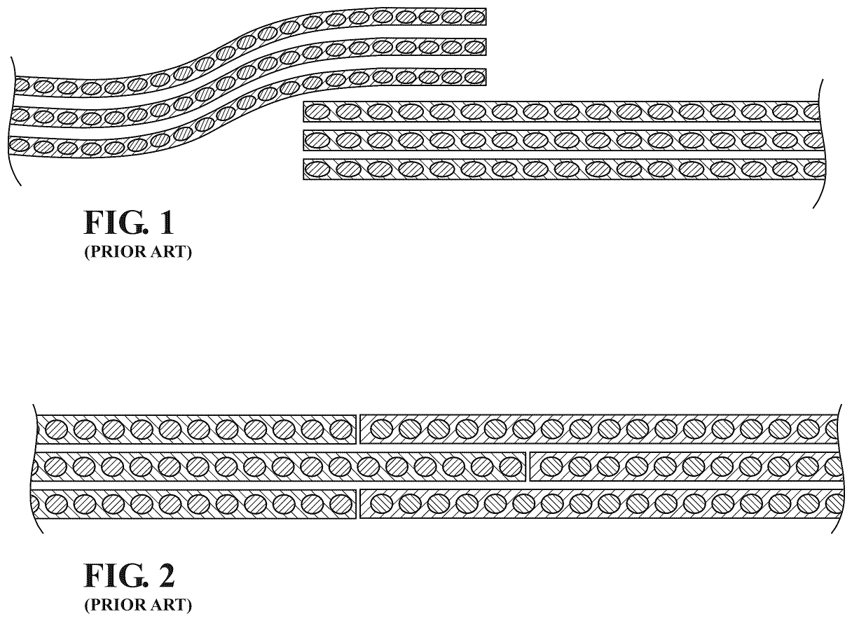

The zones 12 may be formed as a continuous fiber layer having different resin materials used in the different zones 12. As shown in FIG. 1, a first zone 12a may be disposed at and may define an axially inner end portion of the wheel 12, and may further define an inner bead 14. A second zone 12b may extend generally axially outwardly away from the first zone 12a, and may define a generally cylindrical portion 16. A third zone 12c may extend generally axially outwardly from the second zone 12b, and may define a curved or tapered cross-section with a diameter that reduces relative to the second zone 12b along the axial width of the wheel 10, which may be described as a curved portion 18 or stepped portion. A fourth zone 12d may extend generally axially outwardly from the third zone 12c, and may have a diameter that increases relative to the third zone 12c. The fourth zone 12d may define an outer bead 20. It will be appreciated that the reference to extending generally axially outwardly refers to the general direction away from the inner bead 14, and may include tapering or other complex diameter changes, and should not necessarily be interpreted as extending parallel to the rotational axis of the wheel due to the possible tapering and diameter changes.

It will be appreciated that the illustrated arrangement and number of zones 12 may be modified in accordance with design needs. As further described below, the illustrated zones 12a-12d may be tailored to accommodate a particular use environment, such as for temperature resistance or strength at different areas. Of course, given the various temperature and strength needs for different designs, additional zones may be included, or the relative sizes of the illustrated zones 12a-12d may be modified. For purposes of further discussion, the number and arrangement of zones 12a-12d will be referenced herein.

The inner bead 14 and the outer bead 20 may be sized and configured to support a tire (not shown) in a traditional manner, such that the tire may be inflated when mounted and sealed to the wheel 10 in a manner known in the art.

The zones 12 may combine to define an outer surface 22 and an inner surface 24. The outer surface 22 faces radially outward and combines with a mounted tire to define an interior space within the tire in which pressurized air may be introduced to inflate the tire. The inner surface 24 faces radially inward and toward the axis of the rotation of the wheel. The inner surface 24 may be the surface that interfaces with a vehicle braking mechanism or is disposed near or adjacent a braking mechanism (not shown). The braking mechanism, as is known, will generate a substantial amount of heat during operation. In one approach, the third zone 12c that defines the curved portion 18 is the area of the wheel 10 that may interface or be disposed adjacent or near the brake mechanism, and may therefore be the portion of the wheel 10 that receives a large amount of heat from the braking mechanism.

However, it will be appreciated that other zones of the wheel 10 may be subjected to increased temperature due to braking mechanisms, or the like. Accordingly, it will be appreciated that the zone 12c may extend further axial distances to include these areas of increased temperatures. In another aspect, the zone 12b illustrated in FIG. 3 may be the zone that is subjected to increased temperature. For the purposes of discussion, the illustrated zone 12c is the zone subjected to increased temperature.

The inner bead 14 and the outer bead 20 have larger outer diameters relative to the cylindrical portion 16 and the curved portion 18, and are the portions that directly support the tire that is mounted to the wheel 10. Accordingly, the inner bead 14 and the outer bead 20 are the portions of the wheel 10 that receive the majority of an impact load, for instance when impacting a pothole or other road imperfection or bump. The inner bead 14 and outer bead 20 are therefore preferably constructed with high strength and toughness to resist such loads and to prevent or otherwise limit damage in the wheel 10 that could lead to depressurization of the tires and require replacement.

Unlike areas of the wheel 10 disposed near braking mechanisms, the inner bead 14 and the outer bead 20 of the wheel 10 do not typically undergo significant temperature increases during operation. Accordingly, the first zone 12a and the fourth zone 12d may be constructed with a high toughness material but without requiring high temperature performance. Put another way, these zones defining the inner bead 14 and outer bead 20 may have high toughness performance but low temperature performance. In one approach, the resin used for these zones may be an epoxy resin material, but it is understood this may be any polymeric or non-polymeric material. As used herein, the various materials that can be used in the various zones may also be referred to as matrix materials.

The third zone 12c may be the zone that receives a large amount of heat because of its proximity to the brake caliper. In operation, this region of the wheel 10 may undergo temperatures as much as 300 degrees F. above the other zones of the wheel 10. In one approach, a polymer from a different polymer family relative to the first and fourth zones 12a and 12d may be used. For example, a polymer from the Bismaleimide family may be used in the third zone 12c, while the other zones use an epoxy. In general, the matrix material used in this zone 12c may have a higher temperature performance and consequently a lower toughness than the matrix materials used in zones 12a and 12d. The third zone 12c is disposed radially inward relative to the inner bead 14 and the outer bead 20, and therefore does not undergo substantial impact forces from potholes and the like. Accordingly, the third zone 12c may have a relative low toughness performance.

As used herein, reference to low, high, or the like in toughness performance or temperature performance is intended to refer to performance levels relative to other portions of the wheel 10. For example, the zone 12c having a relative low toughness performance may be understood to mean a lower toughness performance relative to the zones 12a and 12d. Similarly, the zones 12a and 12d having a relative high toughness performance may be understood to mean a higher toughness performance than the zone 12c.

The second zone 12b, which is disposed axially between the first zone 12a (requiring high toughness but allowing low temperature performance) and the third zone 12c (requiring high temperature performance but allowing low toughness), may be constructed to have both low toughness and low temperature performance. The second zone 12b may have this low toughness and low temperature performance because this zone does not receive substantial impact loads because it is radially recessed relative to the inner bead 14 and the outer bead 20, and further because it does not undergo substantially high temperatures like the third zone 12c. Thus, the second zone 12b may be constructed using low cost materials because it does not require these levels of high performance. In this aspect, the second zone 12b having low toughness and temperature performance may be understood to mean a lower toughness performance relative to the zones 12a and 12d and a lower temperature performance relative to zone 12c.

Moreover, it will be understood that different zones both being described as having low toughness performance may have differing levels of toughness performance relative to each other. For example, with both the zones 12b and 12c having low toughness performance relative to the zones 12a and 12d, one of the zones 12b or 12c may have a lower toughness performance than the other of zone 12b or 12c.

For the purposes of illustration regarding temperature and strength performance, the following exemplary performance values may be used herein.

Low temperature performance may have a Tg between 80 C and 120 C. High temperature performance may have a Tg above 180 C. Tg refers to the glass-liquid transition, or glass transition, value. Glass-liquid transition, or glass transition, is the gradual and reversible transition in amorphous materials (or in amorphous regions with semicrystalline materials) from a hard and relatively brittle “glassy” state into a viscous or rubbery state as temperature is increased. The glass-transition temperature Tg of a material characterizes the range of temperatures over which this glass transition occurs. The Tg value is lower than the melting temperature of the crystalline state of the material, if one exists.

High toughness performance may refer to a fracture toughness of 1000 J/m∧2 to 2000 J/m∧2. Low toughness performance may refer to a fracture toughness of less than 500 J/m∧2.

With reference to FIG. 4, the multiple zones of the wheel body 12 may be constructed in a continuous manner, unlike the prior art solutions of overlapping or splicing of reinforcements utilizing different matrix systems and separate fiber reinforcement. Rather, the multiple zones of the body 12 of the wheel 10 may have a continuous single fiber reinforcement layer 30, but with multiple different matrix or resin materials across the axial width of the reinforcement layer 30. For example, the single layer 30 may act as the base, skeleton, body, or the like to which the various resin formulations and/or matrix materials are incorporated in the reinforcement layer 30, which may be in the form of a preform. Incorporating the resin formulations into the preform is performed at the reinforcement level. Alternatively, the incorporation of the resin formulations can be performed at the component level or laminate level. As used herein, it will be appreciated that reference to a “continuous” layer in this disclosure does not require that the fiber itself is continuous, but that the layer of fiber is continuous, with various types of fiber arrangements and distributions possible. For example, chopped fibers of various length may be randomly distributed along the continuous layer of fiber. Longer fibers may be controllably distributed in a woven manner or specifically oriented. In each case, the layer of fiber may be considered continuous, even if the individual fibers used are not themselves continuous across the layer.

The reinforcement layer 30 may be made from a carbon-fiber fabric, fiberglass, Kevlar, or similar material suitable for acting as a continuous reinforcement layer. The resin materials or formulations that are carried on the reinforcement layer 30 can be joined with the reinforcement layer 30 in different ways. For purposes of discussion, the combined resin materials may be referred to as a resin layer 40.

In one approach, the resin or matrix materials, in the form of films or layers, can be fully consolidated with the reinforcement layer 30 before the wheel layup process. When the resin or matrix materials are consolidated with the reinforcement layer 30, this may be referred to as the reinforcement layer 30 being impregnated. When the matrix materials and reinforcement layer 30 are consolidated and impregnated prior to the wheel layup process, this approach may be referred to as “prepregged,” where a consolidated preform is defined that can be applied to a mold during the layup process.

In another approach, one or more resin films or layers 40 may be defined, having one or more matrix materials carried on a substrate, and can be applied to the mold along with the reinforcement layer 30 during the wheel layup process. The reinforcement layer 30 and the resin film can be then be consolidated on the mold in a resin film infusion molding process, also known as “RFI.” In this approach, the layers are not “prepregged” because the impregnating occurs on the mold in response to the RFI process. In another approach, a portion of the resin layer 40 is devoid of resin film, leaving a portion of the reinforcement layer 30 uncovered by the resin film layer 40. The consolidated reinforcement and resin film layer 50 can be prepregged or utilize the RFI process. During consolidation and cure, the portion of the reinforcement layer 30 devoid of resin can be infused with resin from the adjacent material zones. Alternatively, this portion of the reinforcement layer 30 can be infused with a resin supplied via resin transfer molding or other infusion process during the molding and curing process.

In either the prepregged process or the RFI process, the matrix materials and the reinforcement layer 30 become consolidated in the consolidated layer 50 in response to the application of heat and pressure.

The various resin materials that may be used for the different zones 12a-12d across the width of the reinforcement layer 30 can be applied as separate films or layers 40 for each material, or as one film or layer 40 with regions of differing resin material. Separate films 40 may be combined with the single reinforcement layer 30 in the prepregged approach or the RFI approach. Similarly, a single layer 40 of multiple resins may be combined with the reinforcement layer 30 in the prepregged approach or the RFI approach. The selection of the prepregged approach vs. the RFI approach can depend on the particular manufacturing capabilities or needs of the user. For example, prepregged layers may require specific handling or storage requirements, and the RFI process may require a specific type of molding equipment.

In the prepregged approach, the resin layer 40 and the reinforcement layer 30 are heated and partially or completely consolidated together to define the single composite layer 50, which includes both the reinforcement layer 30 and the resin layer 40, as shown in FIG. 4A. The fabric-like structure of the reinforcement layer 30 is embedded within the resin layer 40 when the single composite layer 50 is formed. Multiple composite layers 50 may be prepregged, which may then be applied on a mold for performing the wheel layup process.

In the RFI approach, the resin layer 40 and reinforcement layer 30 may be separately placed on the wheel mold, and the RFI process is performed that will consolidate and bond the resin layer 40 to the reinforcement layer 30 under heat and pressure, which will impregnate the resin layer 40 with the reinforcement layer 30 on the mold, creating a molded composite layer 50 in the shape of the mold. FIG. 4A also illustrates the resulting composite layer 50 of the RFI approach having both the reinforcement layer 30 and the resin layer 40 in a single layer.

In each of the above processes, the resin layer 40 is provided and produced before being applied to the reinforcement layer 30. As described above, multiple resin materials are used across the width of the reinforcement layer 30. In the above-described example, there are four zones of the wheel 10 having different toughness or heat requirements and can therefore be four different materials that meet the particular requirements of each zone or region. The resin layer 40 can therefore be provided having multiple materials across its width. The resin layer 40 may include a substrate that may be used to receive the matrix materials, which can later be peeled away.

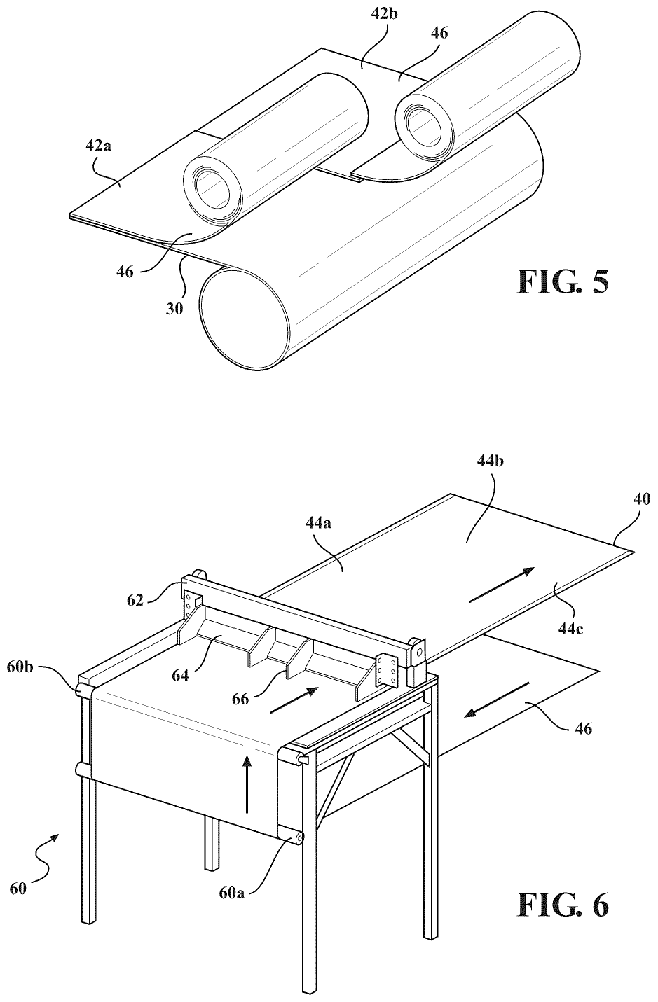

The resin layer 40 can be in the form of multiple separate layers 42a, 42b, etc. (FIG. 5), or the resin layer can be in the form of a single layer with multiple resin portions 44a, 44b, 44c, etc. (FIG. 4). It will be appreciated that FIG. 4 may illustrate either a single layer with multiple resin portions or multiple layers laid side-by-side. FIG. 5 shows an example of multiple separate layers. In each of these cases, the resin layer(s) 40 may be produced prior to being applied to the reinforcement material 30. In the case of separate layers, the resin layer 40 may become a single layer after the separate layers have been consolidated with the reinforcement layer 30. In each of these cases, the resin or matrix material forming the layers or portions may be applied to a substrate 46.

The substrate 46 may be a layer of material on which the resin or matrix materials can be applied, such that the resin layer 40 may be produced and carried on the substrate 46 for later application to the reinforcement layer 30. The substrate 46 may be a paper, polymeric, or other material suitable to act a substrate for a resin material.

In one approach, which may be referred to as the multiple film approach and shown in FIG. 5, the multiple separate resin layers 42a, b, etc. each having a different resin material are produced separately and on separate substrates 46. It will be appreciated that different substrate materials could be used for the separate layers. It will be further appreciated that the same resin materials could be used in separate layers 42a, b, etc. and laid adjacent each other or separated by a layer of a different resin material, depending on the desired performance of the resin material along the width of the reinforcement layer 30. For example, a first resin material may be used for layer 42a, a second resin material may be used for layer 42b, and the first resin material may be used for layer 42c. Or the first material may be used for both zone 42a and 42b, and a second material may be used for zone 42c. The use of different separate layers 42 thereby allows for a modular assembly of resin materials across the width of the reinforcement layer.

The resin films or layers 42 can be produced using various filming processes. For example, the layers 42a, b, etc. may be produced by gravure coating, reverse roll coating, knife-over-roll coating, metering rod coating, slot die coating, curtain coating, all knife coating, spray coating, powder coating, or any other known coating technique. The filming processes, when complete, may therefore produce the multiple separate resin layers 42a, b, etc. It will be appreciated that different layers could be made by different coating processes.

With the multiple layers 42 being produced, they may then be applied to the reinforcement layer 30 for the laminating process. The reinforcement layer 30 and the resin layers 42 may be in the form of a roll of material. The reinforcement layer 30 may be provided, with the separate layers 42 being applied over a surface of the reinforcement layer 30.

In one approach, one of the layers 42 may be applied to the reinforcement layer 30 first, thereby covering a portion of the width of the reinforcement layer 30. The reinforcement layer 30 and the resin layer 42 may then be laminated together, providing a portion of the reinforcement layer 30 in a laminated state. Subsequent resin layers 42 may be applied and laminated in a similar and sequential manner, until the entire width of the reinforcement layer 30 has been covered (or the entire desired amount of the reinforcement layer 30 has been covered). With the multiple matrix materials applied to the reinforcement layer 30, heat and pressure may be applied to consolidate the layers according to the prepregged approach or the RFI approach.

In the RFI approach, the reinforcement layer 30 may be placed on the wheel mold separately from the matrix material layers 42, or the layers may be laminated together and then applied to the mold. In either version of the RFI approach, the layers 42 will be consolidated on the mold to arrive at the consolidated layer 50 illustrated in FIG. 4A.

In another approach, each of the layers 42 may be applied to the reinforcement layer 30 side-by-side generally simultaneously or during the same time period. In this approach, the rolls of the layers 42 may be located side by side and the lamination may occur at the same distance along the reinforcement layer 30. Put another way, at a given longitudinal location along the reinforcement layer 30, the multiple layers 42 may be applied across the width at the same longitudinal location.

This approach of applying multiple separate layers 42 to the reinforcement layer 30 can thereby provide a laminated and prepregged composite layer 50 that may be applied to the wheel mold in the wheel layup process, or a laminated assembly of layers that can be consolidated in the RFI approach. In the prepregged approach, heat and pressure are applied to the overlaid reinforcement layer 30 and layers 42, and the consolidated layer 50 is placed on or in the wheel mold. In the RFI approach, the overlaid layers 30 and 42 are placed on or in the mold prior to applying heat and pressure to create the consolidated layer 50.

With reference to FIG. 6, in another aspect, the resin layer 40, in the form of a single layer with multiple portions 44a, b, c, etc., can be produced and subsequently laminated with the reinforcement layer 30. In this approach, the resin layer 40 may be produced using a filming process in which multiple resin formulations are applied to the substrate 46 at approximately the same time. An example of such a filming process is shown in FIG. 6, in which a filming setup 60 for a knife-over-roll process is illustrated.

In this approach, the substrate 46 may be fed in a first direction toward a lower roller 60a, and directed upward toward an upper roller 60b. At the upper roller 60b, the substrate 46 is directed in a second direction that is opposite the first direction. The substrate 46 may be fed in the second direction toward a doctor blade head 62 having multiple sections 64 with damming 66 disposed between the sections 64. Each section 64 may include a different resin formulation. Thus, as the substrate 46 passes through the sections 64, the different resin formulations may be applied to the substrate 46.

It will be appreciated that in some aspects, the substrate may be fed toward the doctor blade head 62 in another manner, and not necessarily using the two-roller setup illustrated in FIG. 6.

As the substrate 46 passes through the sections 64 and the doctor blade head 62, the resin layer 40 will be formed having different resin material formulations disposed across the width of the substrate 46, yielding a single resin layer 40 with multiple zones. The resin layer 40 may then be removed from the setup 60.

With the resin layer 40 produced using this process, the resin layer 40 is in the form of a single layer, and may then be combined with the reinforcement layer 30 to create the composite layer 50 in a manner similar to that described above for multiple layers. The single resin layer 40 may be applied to the reinforcement layer 30, and heat and pressure may be applied to the resin layer 40 and the reinforcement layer 30 to form the prepregged composite layer 50. The composite layer 50 may then be applied to the mold in the wheel layup process. Alternatively, the single resin layer 40 may be applied to the reinforcement layer, and consolidated as part of an RFI process in the mold.

It will be appreciated that the single layer 40 having multiple different resin zones may also be combined with additional separate layers, and overlaid with the reinforcement layer 30 in a manner similar to that described above for multiple layers 42.

In yet another approach, similar to the above-described approach for forming the single resin layer 40, the substrate material 46 may be fed through multiple filming stations to apply to the multiple resin formulations to the single substrate 46, rather than a single filming station where the resin formulation are added at approximately the same longitudinal location. For example, the substrate 46 may be passed through a first filming station, and the resin material may be applied across a portion of the width of the substrate 46. The substrate 46 may continue to be advanced to a subsequent filming station, where another resin material may be applied across a different portion of the width of the substrate 46. This process may be continued until the desired width of the substrate 46 is covered with the desired resin materials.

In yet another approach, one resin material may be applied to a portion of the substrate 46 at a first filming station, and then multiple resin materials may be applied at a subsequent filming station. For example, a first resin formulation may be applied at a first filming station, and then second and third resin formulations may be applied at the same filming station, with regions separated by damming or the like.

Similar to the above, once all of the desired resin materials have been applied to the substrate 46, the single resin layer 40 may be removed and then applied to the reinforcement layer 30, and they can then be combined under heat and pressure to define a prepregged composite layer 50. The composite layer 50 may then be applied to the wheel mold in the wheel layup process. Attentively, the single resin layer 40 and the reinforcement layer 30 may be consolidated on the mold using an RFI process.

The above-described methods have related to create a prepregged composite layer 50 that is subsequently applied to the wheel mold or creating an assembly of layers for an RFI process that creates a consolidated layer 50 in the mold. In both cases, a resin layer 40 is produced and then combined with a single reinforcement layer 30 under pressure and heat to consolidate the layers. However, the resin material may be applied in other ways, as well.

In one aspect, a direct reinforcement coating process may be used to apply the different resin or matrix materials to the single reinforcement layer 30. In this approach, the substrate material and the separate resin layer may not be used in the manner described above. Instead, the resin material may be applied directly to the reinforcement layer 30. The reinforcement layer 30 may be optionally placed over a backing material, such as a substrate, table, roller, or the like, to limit the resin coating from seeping through the reinforcement layer 30.

Upon coating the reinforcement layer with the resin material directly, the reinforcement layer 30 will include the various resin or matrix materials, and may be placed under heat and pressure to produce the composite layer 50. The composite layer 50 may then be applied to the wheel mold for use in the wheel layup process.

In each of the above methods, the resulting single composite layer 50 includes a continuous fiber reinforcement extending across the width of the composite layer 50. This continuous reinforcement will thereby extend continuously across the width of the wheel 10 that is produced, such that there is no seam or break in the reinforcement layer 30, or an overlap of matrix materials and reinforcing layers. Accordingly, the different portions of the wheel 10 having different temperature or strength requirements can be accommodated with the desired resin formulation in each region that can suit the specific requirements. In this manner, it is not necessary to compromise on the toughness and heat requirements to find a suitable resin that could be applied to all zones. The ability to select a particular resin for the requirement of a particular zone allows for increased toughness capability, increased temperature capability, and reduced cost.

The above description has focused on a single consolidated layer of reinforcement material and matrix materials that are consolidated to define a single consolidated layer 50. It will be appreciated that additional continuous layers can be constructed and layered over each other in the wheel layup process. Unlike the prior art processes, the multiple layers are not spliced together, or overlapping at transitions between matrix materials. Rather, the additional continuous layers can provide additional material to increase the radial thickness of the wheel across its width or at select locations. It is understood a composite single consolidated layer 50 having multiple matrix materials may constitute the entire layer stack or any portion of the layer stack. Equally, the multiple consolidated layers 50 having multiple matrix materials can be positioned anywhere within the entire layer stack.

The above description has been directed to the use of a continuous fiber layer that is impregnated with various matrix materials across its width to be used in the wheel layup process. This continuous fiber layer can also be impregnated and/or used with other material compositions. For instance, the above described continuous fiber layer may be used with a fiber-reinforced molding compound (FRMC) material having different chemistries at different locations, which may be used in a composite wheel construction to provide a composite wheel with different strength and temperature characteristics at different locations in a manner similar to the above.

Thus, in another aspect, additionally or alternatively to the continuous fiber reinforcement layer, the layer of material extending along the axial direction of the wheel may be continuously reinforced in the form of fiber-reinforced molding compound, in which multiple randomly distributed chopped fibers are distributed across the width of the material layer that extends along the axis of the wheel, thereby providing reinforcement from one axial side of the wheel to the other. Along this layer of reinforcement, different strengths and temperature characteristics can be provided in a manner similar to the above. The FRMC material distribution thereby provides a generally continuous reinforcement in the axial direction of the wheel.

FRMC material may refer to both sheet molding compound (SMC) and bulk molding compound (BMC), each of which include glass or carbon fibers integrated with a resin and for use in various molding processes, and which provide increased strength relative to traditional resin formulations.

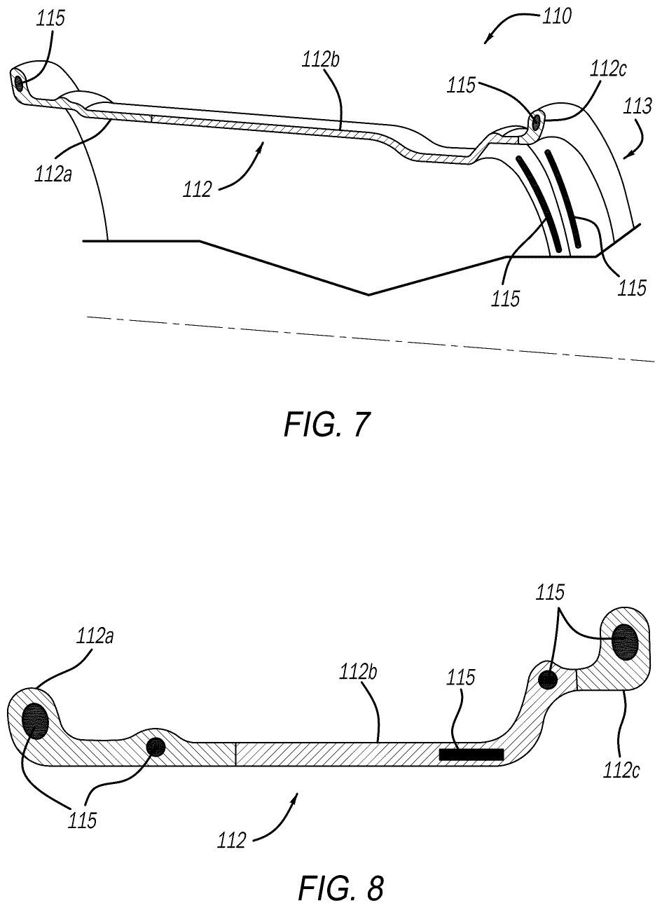

FIG. 7 illustrates a one-piece wheel 110 made from a FRMC material sheet 150 with different chemistries at different sections depending on the desired strength or temperature characteristics of the wheel 110. The one-piece wheel 110 includes a rim portion 112 and a center portion 113. The cross-section of FIG. 7 cross-sectionally illustrates an upper half of the wheel 110 relative to the center axis A of the wheel 110. The center portion 113 may include the mounting structure for mounting to the wheel carrier or vehicle axle (not shown).

FIG. 8 illustrates a similar construction of a wheel rim 112 without a center portion. In both FIGS. 7 and 8, FRMC material with different resin chemistries at different axial sections is used for the construction. For the purposes of discussion, reference will be made to the wheel 110 and/or rim 112, but it will be appreciated that reference to either the wheel 110 and/or rim 112 can also apply to the composite rim 112 of FIG. 8 that does not include the center portion.

As shown in FIG. 7, the wheel 110 includes different FRMC chemistries at different locations or zones. A first zone 112a (or zone 1) is shown on the left side of FIG. 7. The first zone 112a has a first FRMC resin chemistry. A second zone 112b (or zone 2) is shown in a middle section of the rim 112 and has a second FRMC resin chemistry. A further zone 112c is shown on the right side of FIG. 7 at the opposite axial end of the rim 112 from the first zone 112a. This further zone 112c can have yet another resin chemistry, or may have the same chemistry as zone 1 or zone 2. The various reasons for selecting a particular resin chemistry for a particular section of the wheel was described previously, but in general the different chemistries may be selected to provide different strength or temperature characteristics in different wheel sections to account for the different requirements at these sections in view of the expected use.

The center portion 113 can also be made of an FRMC material, and can have the first chemistry, second chemistry, or a further chemistry, and/or multiple different chemistries. In addition to the FRMC material and the associated reinforcement that it provides, additional reinforcement material can also be provided in the center portion 113, including unidirectional carbon fiber, fiberglass, and/or the like, in a manner consistent with the use of additional reinforcement materials provided in the wheel layup process.

In addition to the different chemistries at different sections of portions of the wheel 110, the wheel 110 or rim 112 can also include an embedded oriented fiber reinforcement 115. The oriented fiber reinforcement 115 may be positioned at various locations where additional strength or reinforcement is desired. The orientation of the fiber reinforcement may be such that it revolves around the axis A in a substantially closed loop circumferentially through the entire wheel, or through circumferential sections, and may be distinct and separate from other fiber reinforcements 115 at different locations. The fiber reinforcement 115 may be in the form of a rod or may be in the form of a sheet. The fiber reinforcements 115 may be added to the sheet of FRMC material during the layup process between layers of the material or otherwise as desired.

The wheel 110, and the rim portion 112 and/or center portion 113, may ultimately be constructed using a traditional lay-up process in which multiple layers are applied into or onto a wheel mold (not shown). Thus, more than one layer of material may be present for a given location or section along the wheel, rim, and/or center structure.

With regard to the one-piece wheel 110 shown in FIG. 7, in one aspect, the center portion 113 may be constructed of FRMC material with a resin chemistry resulting in high-temperature resistance. The center portion 113 of the wheel 110 can be exposed to relatively high temperatures, and therefore the FRMC with a resin having high-temperature resistance is desirable.

Optionally, the center portion 113 may include the continuous fiber reinforcement layer 30 described above in at least one of the material layers of the center portion 113.

With regard to the rim portion 112, at least one of the layers used to construct the rim portion 112 may include a high temperature resistance resin chemistry at one axial location along the rim 112 and a high toughness resin chemistry at another axial location along the rim 112. The rim 112 includes at least one layer of FRMC material. In one aspect, the FRMC material layer has the multiple resin chemistries that provide the different temperature and toughness levels.

Similar to the center portion 113, the rim 112 may also include at least one material layer having the continuous fiber reinforcement layer 30.

For the rim 112 shown in FIG. 8, the above discussion regarding the rim portion 112 is similarly applicable. The rim 112 may include at least one FRMC material layer with different resin chemistries and different strength and temperature characteristics at different axial locations. Optionally, the rim 112 may include at least one layer with the continuous fiber reinforcement layer 30, as well as the optional oriented fiber reinforcements 115.

The FRMC material may be provided in the form of FRMC material 150, which has different chemistries at different locations across its width. For the purposes of discussion, the width of the sheet shall be interpreted as being the axial direction of the FRMC material 150 when rolled, which generally corresponds to the axial direction of the wheel 110 that will be formed from the sheet 150.

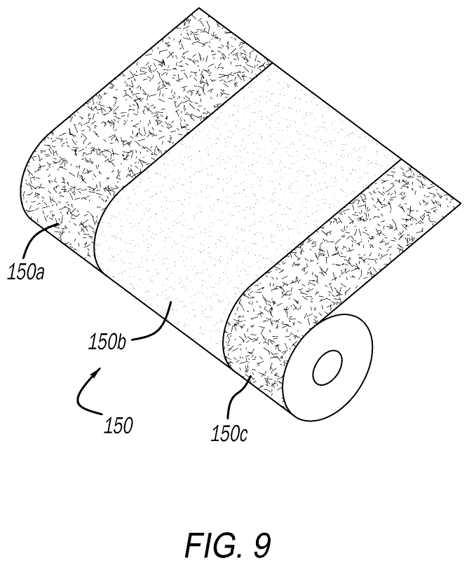

FIG. 9 illustrates a roll of the FRMC material 150 following its construction. The FRMC material 150 includes first, second, and third zones 150a, 150b, and 150c. The first zone 150a has a first resin chemistry. The second zone 150b has a second resin chemistry. The third zone 150c has a further resin chemistry, which may be the same or different that the first or second chemistries. Regardless of the specific chemistries used, the FRMC material 150 has different chemistries across its width at different zones or sections. These different chemistries can be selected based on the desired strength and temperature performance of the particular wheel where this FRMC material will be applied. Generally, the width of the FRMC material 150 can correspond to the axial width/axial span of the wheel 110 or rim 112 to be constructed.

The roll of the FRMC material 150 shown in FIG. 9 may also be referred to as an FRMC prepreg roll, in which the FRMC has been provided into or onto a carrier film (being a combination of resin and fibers on a carrier film) and laminated and impregnated to define the FRMC material 150. The present disclosure provides various methods for the construction of the prepreg roll of the FRMC material 150 shown in FIG. 9. In the below described methods, in each case a carrier film is provided, which may include resin pre-deposited on the film or where resin is later deposited, with the resin and fibers ultimately being combined with the carrier film resulting in the FRMC material 150, which can then be stored as a roll.

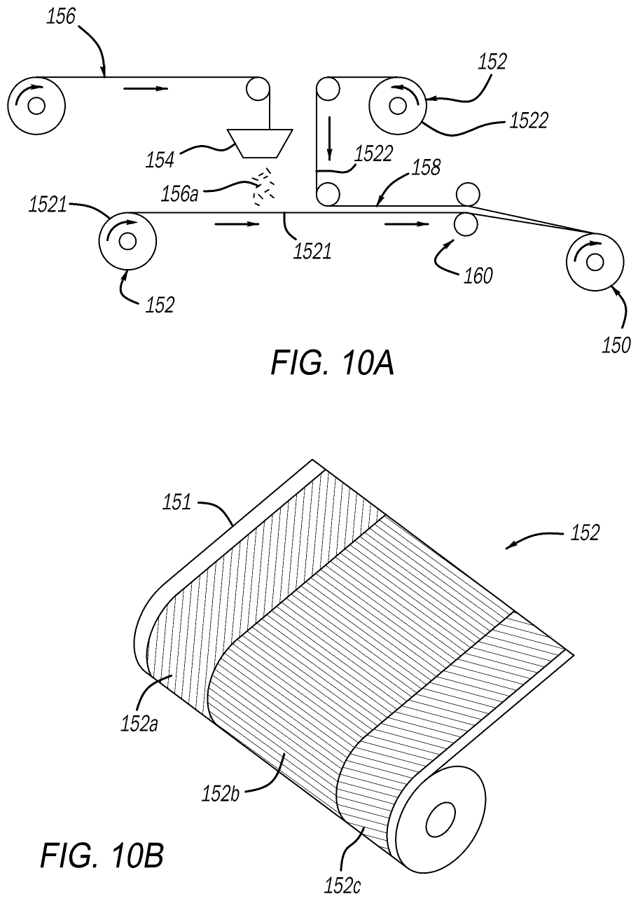

FIG. 10A illustrates a first method for constructing the FRMC material 150 with multiple resin chemistries. FIG. 10B illustrates a single carrier film 152 in the form of a multi-resin film 152, in particular in the form of a plastic carrier film with three different resins 152a, 152b, 152c disposed across the lateral width of the film 152. FIG. 10A illustrates the use of two rolls of multi-resin film 152, which are ultimately disposed above and below the randomly distributed reinforcement fiber.

As shown, a first roll of the multi-resin film 152, which may be referred to as film 1521 is provided on the left side of the system. This roll of the film 1521 provides the multi-resin film in a left to right direction in the figure. Downstream from the first roll of film 1521, a chopper 154 is disposed above the film 1521 that is passing below. The chopper 154 receives reinforcement fiber 156 (which may also be provided on a roll or sheet). The reinforcement fiber 156 is fed into the chopper 154, which chops up the fiber 156 and distributes the chopped fibers 156a onto the film 1521 passing below. The chopped fibers 156a are distributed randomly on the film 1521.

The fibers 156 may be various types of fibers typically used in FRMC, such as glass fibers or carbon fibers. The fibers 156 may have a length of greater than one inch, in one aspect, which provides for added strength across the multi-resin film.

The film 1521, having the chopped fibers 156a, proceeds toward a location of a second roll of multi-resin film 1522. The second multi-resin film 1522 is disposed onto the film 1521 having the chopped fibers 156a, creating a lamination 158 above and below the randomly deposited chopped fibers 156a. The rolls 1521, 1522 are arranged such that in the lamination 158, the same resin chemistry is overlaid with a matching chemistry when the films 1521, 1522 are brought together to laminate the fibers 156a. Put another way, the resins layered together on the left edge match each other, the resins in the middle match each other, etc.

The lamination 158 proceeds to be fed toward an impregnation station 160, where the film layers 1521, 1522 with the resins are impregnated and joined together with the chopped fibers 156a, which were deposited between the film layers 1521, 1522, and thereby the layers are reinforced with the chopped fibers 156a, creating the FRMC material 150, which is then rolled up to define the roll of FRMC material 150.

The above method has been described as using multiple existing pre-deposited carrier films in the form of multi-resin film 152, which may include the resin materials deposited on a carrier film 151. However, the multi-resin films 152 can also be created in line with the provision of the chopped fiber onto the multi-resin film. For example, a bare plastic carrier film 151 can be provided at a first stage, with the various resins (152a, 152b, etc.) being provided onto the bare carrier film 151, the combination of which creates multi-resin film 152, after which the chopped fibers 156 are provided onto the now created multi-resin film 152.

In another aspect, chopped fiber 156a may be provided onto a bare plastic carrier film 151, with the multiple resins (152a, 152b, etc.) then being provided directly onto and mixed with the chopped fiber 156a reinforcement material, which was present on the carrier film 151 prior to the depositing of the resins, with lamination occurring downstream.

In each case, the method of FIG. 10 generally relates to combining chopped fibers 156a with a single multi-resin film 152 above and below. It will be appreciated that the reference to the single film refers to the film either above or below the fibers 156 in the lamination, and that two single films are overlaid in this example.

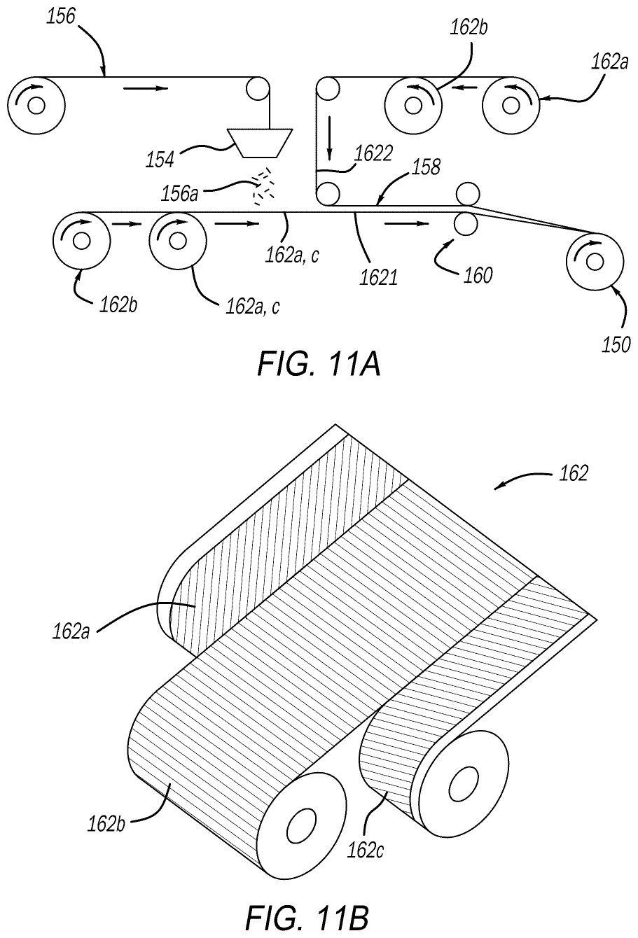

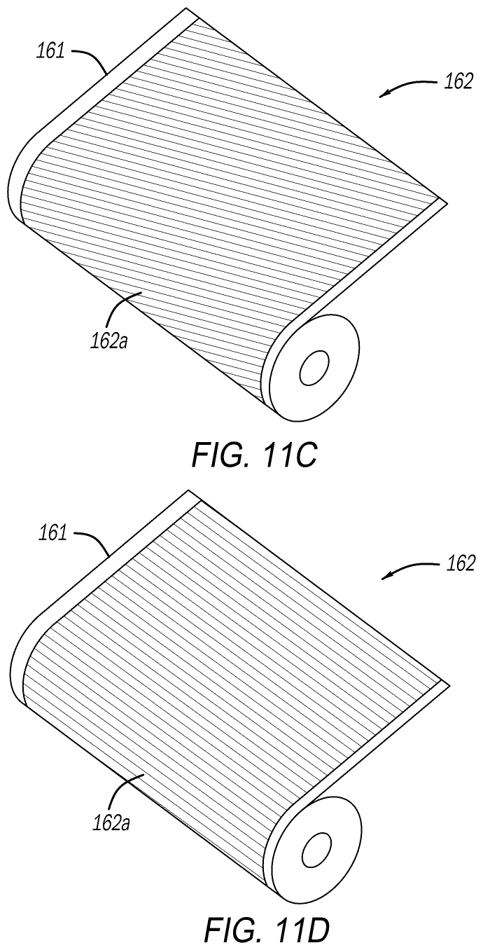

In another aspect, FIG. 11A provides a system and method for producing the FRMC material 150 from separate side-by-side resin films 162, in contrast to the single multi-resin film 152 that spans across the width of the film roll 150 to be created, which was described above in FIG. 10.

The separate films 162 may include first, second, and third resin films 162a, 162b, and 162c, which may be deposited on carrier film 161, similar to carrier film 151. For the purposes of discussion, each of these resin films will described as being different resin chemistries, however, it will be appreciated that additional resin films may be used, and that one or more of the various separate resin films being provided may have the same resin chemistry, with the resulting FRMC film roll 150 having a different resin chemistry at one section relative to another.

Similar to the roll of multi-resin film 152, the resin films 162a, 162b, 162c may each have a resin disposed on the plastic carrier film 161 and may be provided in the form of a roll. Similar to the multi-resin film 152, the separate films 162 are paired and layered with matching films to create a lamination 168. For example, an initial first resin film 1621 is provided, which receives the chopped fibers 156a, and a further first resin film 1622 is overlaid on the first film 1621 when creating the lamination 168.

As shown in FIG. 11B-D, each of the films 162a-c have a width that is less than the overall width of the resulting finished FRMC sheet 150. The films 162 are arranged and provided side-by-side and adjacent to each other to generally define the resulting overall width. Each of the films 162 are arranged upstream from the chopper 154. The films 162 are each provided from their individual rolls, which can occur at different locations along the system, or at generally the same location.

With the films 162a-c each provided and arranged side-by-side to span the width of the resulting roll 150, and the chopped fiber 156a is provided onto the adjacent assembled films 162a-c. After the chopped fiber 156 has been provided randomly across the combined width of the first films 1621 having resins from films 162a-c, corresponding separate films 1622 are laminated over the chopped fibers 156a that were deposited on the underlying films 1621 to create lamination 168. The lamination 168 continues toward the impregnation station 160. The films 1621, 1622 and chopped fiber 156a are impregnated together to define the FRMC material 150, which is rolled up a roll of FRMC material 150.

Similar to the method of FIG. 10, rather that provide the different separate films 162 in a pre-deposited roll, the films 162 with the resins 162a-c can be created in-line with the system, where bare plastic carrier films 161 are provided, and the different resins are provided onto the bare carrier films 161 as they are fed toward the chopper 154 to receive the fibers, and prior to creating the lamination 168.

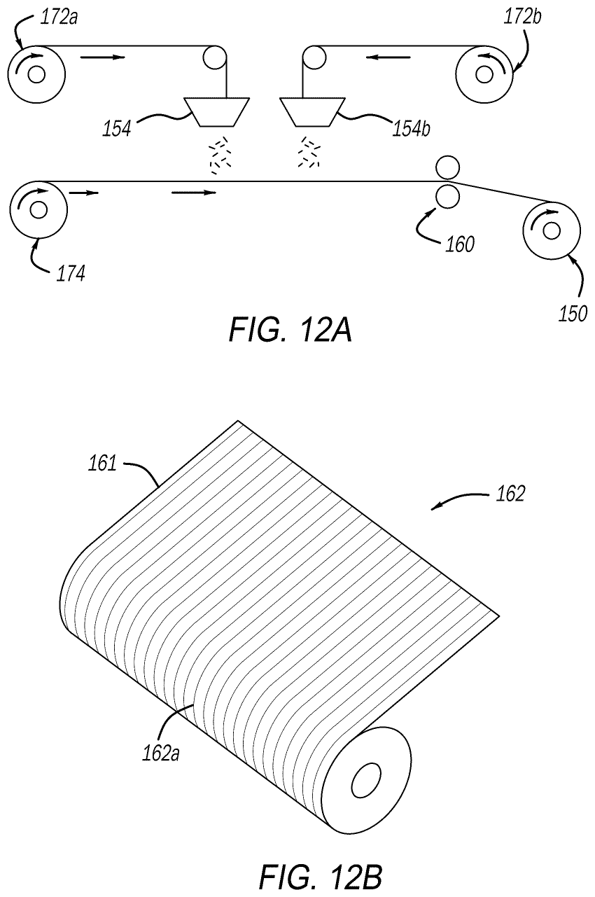

FIG. 12A-B provides another method of constructing the FRMC roll 150. As shown in FIG. 12A multiple rolls of unidirectional prepreg material 172 are provided, which are chopped and deposited on a carrier film 174. Unlike FIGS. 10 and 11, the carrier film 174 is not initially provided with the resin material. Rather, the roll of unidirectional prepreg material 172 is formed in an earlier process. For example, in an earlier process, a single resin material is impregnated with unidirectional fibers and formed into the unidirectional prepreg roll 172, which includes a single resin. These single resin unidirectional prepreg rolls 172 can be chopped up at a chopper disposed at a given location, such that a selected combination of resin and fibers can be selectively deposited at different locations across the carrier film 174. More particularly, the prepreg material 172 (which includes resin and fiber) is slit, chopped, and deposited on a section of the bare carrier film 174. In one aspect, the bare carrier film may be paper.

As shown in FIG. 12A, the carrier film 174 is distributed from a roll and fed toward a first chopper 154a and a second chopper 154b. The first chopper 154a receives a first unidirectional prepreg material 172a (which includes a first resin and a fiber) and chops the unidirectional prepreg material 172a, which is deposited onto a section of the carrier film 174. The first chopper 154a is disposed above a specific lateral section the carrier film 174, such as along an edge section. However, the first chopper 154a could also be in the middle of the film 174 or at the right edge, or along some other section along the width of the film. The first chopper 154a is disposed upstream of the second chopper 154b, but it will be appreciated that different relative locations along the length of the system may be used.

The second chopper 154b receives a second unidirectional prepreg material 172b (which includes a combination of resin and fibers) having a different resin chemistry than the first prepreg material 172a. Thus, a different section of the carrier film 174 will receive a different resin chemistry. The second chopper 154b is arranged at a different lateral section of the carrier film 174 (for example in a middle section, or some other section different from the lateral location of the first chopper 154a). Thus, the chopped second prepreg material 172b will be deposited adjacent to or in a different lateral section relative to the chopped first material 172a.

The choppers 154a and 154b are shown at different locations along the length of the system, such that the first chopper 154a deposits material before the second chopper 154b. However, it will be appreciated that the choppers 154a and 154b may be at the same location or other different locations along the length of the system relative to each other. Of course, additional choppers may be provided for providing different resins at different sections of the lateral width of the carrier film 174. With the chopped unidirectional prepreg material 172 disposed on the carrier film 174, the film 174 is fed through the impregnation station 160, thereby creating the FRMC material 150 with the different resin chemistries in different lateral sections, which is then rolled up into the roll of FRMC material 150.

The unidirectional prepreg material is shown in the form of a roll 172, having been created in a separate process. However, it will be appreciated that these unidirectional prepreg materials may also be provided in line with the process of FIG. 12. For example, a bare carrier film (similar to films 151 or 161) may receive resins, or a film with resin can be provided, upstream, followed by lamination and impregnating the resin film with unidirectional fibers, which is then fed toward the first or second chopper 154a, 154b for being deposited onto the different sections of the carrier film 174.

In another embodiment, the unidirectional prepreg 172 described above can be slit, chopped, and deposited (sprinkled) directly into a cure tool, layup tool, or preforming tool. This allows the making of the FRMC roll 150 to be skipped. Instead, the narrow, chopped prepregs 172 of different resin chemistries can be deposited directly into different lateral sections of a mold tool to lay up the complete part or portions of the part. From these deposited prepregs, a reinforced layer of material can be created in the mold and have different resin chemistries at different lateral sections.

In each of the above processes of FIGS. 10-12, a roll of FRMC material 150 with different resin chemistries in different sections results from the process, and can be provided for use in the wheel layup process. This material 150 may be provided onto the wheel layup mold and aligned so that the different resin chemistries are disposed at the desired axial locations of the wheel 110, rim 112, and/or center 113.

In yet another aspect, an alternative method of using FRMC material in a wheel layup process is provided. In this method, separate sheets of different FRMC material are provided directly to the wheel mold in the layup process. The materials may be arranged adjacent each other, such that one FRMC material is in one axial portion of the rim 112 and another FRMC material is in another axial portion of the rim 112. Additional FRMC material sheets with the same or different chemistries may be provide in additional locations of the rim 112 or center 113. In this approach, the separate sheets of the FRMC materials may overlap each other or may abut each other. The wheel layup process, molding, and curing can continue according to the known molding process.

Each of the above processes regarding the FRMC material may be arranged and/or modified according to the needs of the user. For instance, the reinforcement fibers 156 can be chopped in line with the processes, as shown, or the fibers 156 can be chopped in a separate process and then provided onto the various carriers and/or films.

In each case, the various resin chemistries may have different toughness characteristics. In each case, the various resin chemistries may have different glass transition temperature properties.

The resin chemistries can have different resin chemistry types. For example, the resins can be BMI, epoxy, polyurethane, etc.

The FRMC material, however formed, can be used to form a fiber-reinforced polymer rim preform and/or a fiber-reinforced polymer center preform.

The FRMC material may be in a sheet format and referred to as sheet molding compound (SMC) and/or may be provided in a non-sheet format and may be referred to as bulk molding compound (BMC).

In the resulting wheel 110, rim 112, and/or center 113, the outermost ply of the composite may be fabric or FRMC. In this outermost ply, the layer may include UV-stable resin chemistry. The outermost play may utilize a different resin chemistry than the rest of the wheel and/or underlying layers. The outermost layer may have high thermal dissipation properties or insulating properties.

The various resin chemistries may be developed to have similar or dissimilar rheology properties.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

What is claimed is:

1. A composite wheel structure comprising:
a wheel body defining an axis of rotation, an axial extent, and a first axial section and a second axial section adjacent the first axial section disposed within the axial extent;
at least one layer of composite material extending axially through the first and second axial sections;
wherein the composite material is a fiber-reinforced molding compound (FRMC) material having a plurality of fibers distributed randomly along the axial extent through the first and second axial sections;
wherein the FRMC material has a first resin chemistry in the first axial section and a second resin chemistry in the second axial section, wherein the first and second resin chemistries are different and have different strength and temperature characteristics.

2. The composite wheel of claim 1, further comprising at least one oriented fiber reinforcement extending circumferentially through the FRMC material and fully around the axis of rotation.

3. The composite wheel of claim 1, further comprising at least one continuous fiber reinforcement layer extending circumferentially fully around the axis of rotation and axially through the first and second axial sections.

4. The composite wheel of claim 1, wherein the wheel body includes a rim and a wheel center integrally formed with an axial end section of the rim, wherein the wheel center includes at least one layer of FRMC material.

5. A method of creating a fiber-reinforced molding compound (FRMC) for use in constructing a composite wheel structure, the method comprising:
providing at least one carrier film having an overall lateral width;
depositing chopped fibers randomly onto the at least one carrier film;
combining the chopped fibers with first and second resins on the at least one carrier film, wherein the first and second resins having different resin chemistries, wherein the first resin is disposed in a first lateral section of the overall lateral width and the second resin is disposed on a second lateral section of the overall lateral width; and
impregnating the first and second resins with the chopped fibers and defining a FRMC material.

6. The method of claim 5, wherein the at least one carrier film is a single carrier film having the overall lateral width and the first and second resins are each deposited on the single carrier film.

7. The method of claim 6, wherein the first and second resins are deposited on the single carrier film prior to depositing the chopped fibers onto the single carrier film.

8. The method of claim 5, wherein the at least one carrier film comprises a first carrier film and a second carrier film, wherein the first carrier film defines a first lateral width and the second carrier film defines a second lateral width, wherein the first and second lateral width combine to define at least a portion of the overall lateral width, wherein the first resin is disposed on the first carrier film and the second resin is disposed on the second carrier film.

9. The method of claim 8, wherein the first resin is deposited on the first carrier film prior to depositing the chopped fibers and the second resin is deposited on the second carrier film prior to depositing the chopped fibers.

10. The method of claim 5 further comprising laminating the chopped fibers with at least one further carrier film applied onto the chopped fibers.

11. The method of claim 10, wherein the further carrier film has further first and second resins, wherein the further carrier film is laminated such that the further first resin overlies the first resin, and the further second resin overlies the second resin.

12. The method of claim 5, wherein the chopped fibers are provided from a roll of reinforcement fiber.

13. The method of claim 5, wherein the chopped fibers are provided from a unidirectional prepreg material having unidirectional fibers and the first or second resin, wherein the unidirectional prepreg material is chopped and provides both the chopped fibers and the first or second resin onto the at least one carrier film.

14. The method of claim 5, wherein the FRMC material is formed into a roll after the impregnation step.

15. The method of claim 5, further comprising layering the FRMC material on a wheel mold, such that a first axial section of the wheel mold has the first resin with the chopped fibers and a second axial section of the wheel mold has the second resin with the chopped fibers, and forming a composite wheel having the FRMC material with different resin chemistries in different axial sections of the composite wheel.

16. The method of claim 5, wherein the at least one carrier film is provided as a bare carrier film from a roll without the first and/or second resins, and the first and second resins are deposited on the at least one carrier film in line with the depositing, combining, and impregnating steps.

17. The method of claim 16, wherein the depositing of the chopped fibers onto the at least one carrier film occurs prior to depositing the first and/or second resin.

18. The method of claim 5, wherein the at least one carrier film is provided from a roll with the first and/or second resin pre-deposited on the roll.

19. The method of claim 5, wherein the chopped fibers are deposited randomly and continuously across the overall lateral width of the at least one carrier film.

20. A method of constructing a reinforced composite wheel on a mold tool having an axial extent, the method comprising:
providing a first unidirectional prepreg material having a first resin chemistry and unidirectional reinforcing fibers;
providing a second unidirectional prepreg material having a second resin chemistry and unidirectional reinforcing fibers;
slicing and chopping the first unidirectional prepreg material to define a first chopped prepreg;
slicing and chopping the second unidirectional prepreg material to define a second chopped prepreg;
depositing the first chopped prepreg directly onto a first axial section of the mold tool;
depositing the second chopped prepreg directly onto a second axial section of the mold tool; and
producing a fiber-reinforced layer of material in the mold tool from the first and second chopped prepregs, wherein the fiber-reinforced layer of material has different resin chemistries at different axial sections of the mold for producing a composite wheel having an axial extent with different resin chemistries at different axial sections.
